(19) United States
(12) Patent Application Publication
(10) Pub. No.: US 2003/0218061 A1
(43) Pub. Date: Nov. 27, 2003

(54) Distributed signature verification with dynamic database of reference signatures

(75) Inventor: Alexander Filatov, Longmont, CO (US)

Correspondence Address: MERCHANT & GOULD PC, P.O. BOX 2903, MINNEAPOLIS, MN, 55402-0903, US

(73) Assignee: Parascript LLC

(21) Appl. No.: 10/155,453

(22) Filed: May 23, 2002

(51) Int. Cl. G06F 17/60; G06F 7/08

(52) U.S. Cl. 235/379

(57) ABSTRACT

Information is provided to a point of sale system to assist a sales clerk in preventing a bank check having a fraudulent signature from being accepted at the point of sale. The check signature is scanned from the bank check and an account identifier is read from the bank check. A reference signature set associated with the account identifier is retrieved from the database. The check signature is compared against reference signatures in the reference signature set to verify the check signature and generate a signature confidence value based on how closely the check signature matches one or more of the reference signatures. The signature confidence value is tested against a predetermined value to accept or not accept the check signature. An accept check message is sent to the point of sale system if the act of testing verifies the check signature. The check signature is added to the reference signature set for the checking account identified by the check identifier if the check signature is verified. If the check signature is not verified, the reference signature set is sent to the point of sale system for use by the sales clerk in visual inspection of the check. An account tracking service is called if the reference signature set is not in the database. The account tracking service checks the account identifier against a list of accounts that have a history of one or more bad checks being issued.

### TECHNICAL FIELD

The invention relates to the prevention of acceptance of fraudulent checks at a transaction terminal. More particular this invention relates to the verification of signatures on checks at a point-of-sale station communicating with a signature verification computing system using a dynamically updateable database of reference signatures of the account holders for the checks.

### BACKGROUND OF THE INVENTION

At the present time it is estimated that retail outlets throughout the nation lose somewhere between twelve billion and fifteen billion dollars annual due to acceptance of bad checks. As a result account tracking companies were created to keep records of check use history and bad checks for checking accounts. Retail stores cooperate with these account tracking companies to provide account information for checks to the account tracking companies. The account tracking companies store a list of accounts in an account database, and for each account they store a range of values for typical amounts, typical geographic location, frequency of use and bad check incidents.

The success of this account tracking approach depends on the number of stores contributing information to track checking accounts. The larger the number of contributors to the database of accounts, the more reliable and successful will be the tracking of the accounts. For example one such account tracking company receives its information from the majority of the large national companies with retail stores in communities all across America. Another account tracking company does not have necessarily large national corporate clients but rather accumulates account information from about twelve thousand retail stores operated by smaller clients. These account tracking companies are not banks; they are separate service providers providing a review of account numbers against an account database to a large number of retail stores that subscribe to the service and in turn provide account information to the service. As useful as this account tracking approach is, it still only prevents about 20% of all the losses due to bad checks.

It is estimated that 30% to 50% of the losses are due to account holder signature forgery. The account tracking system is not effective against forgery as it may take up to thirty days, one bank cycle, before an account holder realizes that someone has improperly issued checks on his or her account. Verifying signatures at the point of sale would of course detect bad checks, but stores are often reluctant to do so as it slows down the transaction. Further, even if the store clerk checks the signature against another record carried by the forger, the clerk may not detect the forgery. If the forger produces a drivers license, the signatures compared by the clerk will match. The drivers license might be forged or the clerk may not check the name and address printed on the check against the name and address printed on the drivers license. Also if the forger has also stolen the account holder's driver license, the forger may be able to forge the account holder's signature well enough to fool the clerk.

It is with respect to these considerations and others that the present invention has been made.

### SUMMARY OF THE INVENTION

In accordance with the present invention, the above and other problems are solved by verifying a customer signature on a funds document, such as a bank check, credit or debit document, received in a transaction at a point of sale station. The funds document is drawn on an account identified by an account number on the funds document. Customer signatures from previous transactions are stored as reference signatures in a reference signature set for an account number. The customer signatures and account number are received from one or more point of sale stations as a result of a plurality of transactions at the stations. The reference signature set based on the account number identified in the current transaction is retrieved and compared against the current customer signature from the current transaction to detect whether or not there is a match between the current customer signature and one or more reference signatures for the account. If there is a match between the current customer signature and one or more reference signatures, a valid signature message is sent to the point of sale station. If the current customer signature does not match one or more reference signatures, the reference signature set is sent to the point of sale station.

When a valid signature message is received at the point of sale station, the valid signature message and a first dialogue is displayed. The dialogue guides the clerk through acceptance of the funds document. In response to a valid signature message the current customer signature is added as a reference signature to the reference signature set for the account number. When a reference signature set is received, i.e. indicating the signature was not verified, the reference signature set is displayed at the point of sale station along with a second dialogue to guide the sales clerk through a visual inspection of the signature on the funds document. If the clerk decides to accept the funds document, a funds document accepted input at the point of sale station adds the current customer signature to the reference signature set.

The invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### BRIEF DESCRIPTION OF THE DRAWINGS

FIG. 1 shows one embodiment of the invention with a processor at a point of sale station communicating with a verification system to provide signature verification.

FIG. 2 illustrates an exemplary computing system that may be programmed to perform the operations at the point of sale processor station and at the verification system.

FIG. 3 shows the operations performed by the point of sale processor in FIG. 1.

FIG. 4 shows the operations performed by the verification system in FIG. 1.

FIG. 5 illustrates another embodiment for the verification system where the account review is performed in the verification system along with signature verification in deciding whether to accept the check.

### DETAILED DESCRIPTION OF THE INVENTION

The logical operations of the various embodiments of the present invention are implemented (1) as a sequence of computer implemented steps or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein may be referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

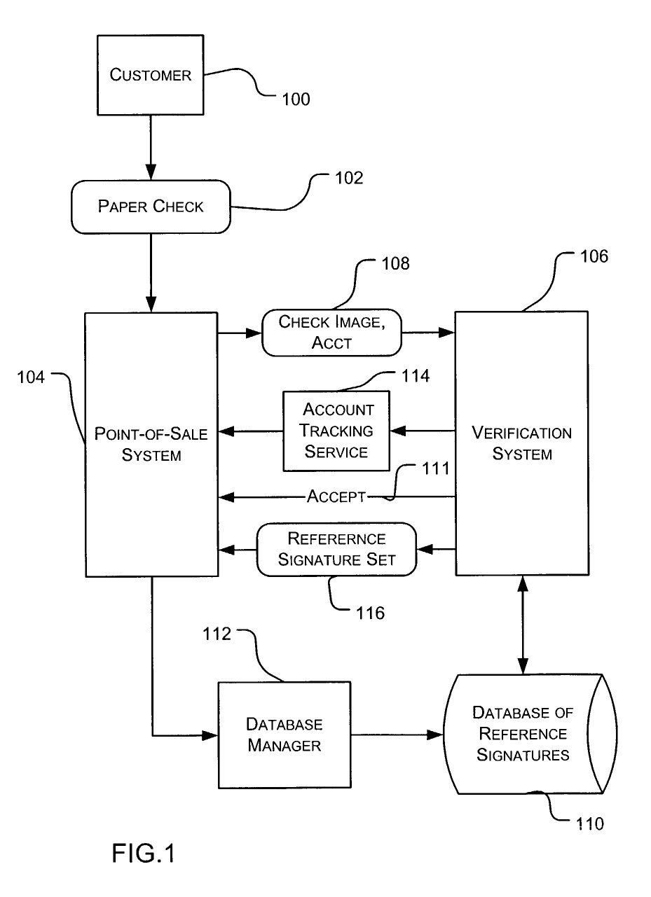

FIG. 1 illustrates one embodiment of the invention and discloses the communications that occur between a point of sale system 104 and a verification system 106. A customer arrives at a point of sale station having a point of sale computing system and offers to pay for the transaction with a paper check drawn on his checking account. The sales clerk at the point of sale station then inserts the paper check or transaction check into a scanner in the point of sale system. The scanner scans the check and creates an image of the check for use by the point of sale system and the verification system. The scanner also scans the MICR (magnetic ink character recognition) characters printed at the bottom of the check. These MICR characters are read by the point of sale system and identify the bank account on which the funds recited on the paper check are drawn. The check image and the MICR account information 108 are sent to the verification system as well as being provided to the point of sale system. Alternatively, the point of sale system could just send an image of the customer signature on the check and the account number as read by the point of sale system.

Verification system 106 will endeavor to verify the signature on the check by comparing the signature to a reference set of signatures from database 110. If the verification system can verify the signature it will return an accept message 111 to the point of sale system. The point of sale system 104 will then display an accept message to the sales clerk and will forward a signature message to database manager module 112. The signature message includes an image of the check signature and the account number or account identifier. Database manager module 112 will add the check signature of the check just accepted to the reference set of signatures for the account identified by the account number or identifier. Thus, the reference set of signatures for that account in the database 110 will have a new signature added to the reference set of signatures for that account. The database manager 112 and the database 110 are shown as a separate computing system remote from the verification system; however they could be a part of the verification system 106.

The verification system will receive the account number or MICR codes of the transaction check from the point of sale station and attempt to retrieve a reference signature set for that account number. In the event that the verification system 106 cannot find an account record for the account number, the verification system will call the account tracking service 114. The account tracking service contains a list of records by checking account number. The records include bad check incidents and a use history for checks in the checking account tracked by the service. The use history includes parameters such as a range of typical check amounts, a typical geographic location for use of the checks and a typical frequency of use range for the checks. If the account record has a bad check incident, a warning message will go from the account tracking service 114 to the point of sale system 104 to warn the sales clerk about the check. If the check is outside the parameters of use for the checking account, a warning message will go from the account tracking service 114 to the point of sale system 104 to warn the sales clerk about the check. If neither event occurs, the point of sale system receives a message that signatures are not in verification system. The sales clerk, based on rules at the retail store, may refuse the check or proceed to some other evaluation process to evaluate the check.

If the verification system 106 finds a reference signature set in database 110 for the account identified by the MICR codes, but cannot verify the signature, then the verification system will send an electronic image of signatures in the reference signature set back to the point of sale system 104. The point of sale system will display to the sales clerk a plurality of signatures from the referenced signature set. The reference signatures would be displayed by the point of sale system along side a display of the signature on the transaction check as just scanned in. The sales clerk may then evaluate by visual inspection and decide to accept or reject the check.

In summary, verification system 106 will endeavor to verify the signature on the check against a reference set of signatures for the same account as stored in the database 110. If it can verify the signature, it will signal the point of sale system 104 to accept the check and to send the image of the signature on the check to the database 110 to update the reference signature set for that account. If the verification system 106 cannot verify the check signature against the reference set of signatures from database 110, it will either call the account tracking service 114 to ask the service to review the account number of the transaction check for departure from use history parameters or for a bad check incident, or it will send the reference signature set, if it has such a set, for the sales clerk to use in a visual inspection of the signature on the transaction check.

While the embodiments of the invention described herein describe verification of the signature on a bank check, the operations of the invention may be performed to verify the signature on any funds document such as a credit card document or debit card document. The funds document may be any document that identifies an account, allows the account holder to draw upon funds (credit or debit) associated with the account and requires the signature of the account holder to execute the transaction.

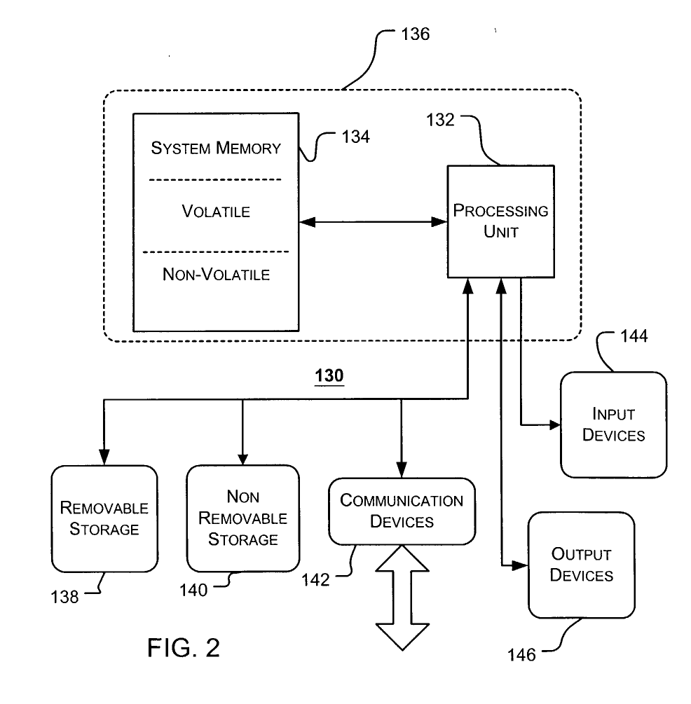

An exemplary computing system 130 for implementing the operations at the point of sale station and at the verification system is shown in FIG. 2. In its most basic configuration, computing system 130 typically includes at least one processing unit 132 and memory 134. Depending on the exact configuration and type of computing system, memory 134 may be volatile (such as RAM), non-volatile (such as ROM, flash memory, etc.) or some combination of the two. This most basic configuration is illustrated in FIG. 2 by dashed line 136. Additionally, system 130 may also include additional storage (removable and/or non-removable) including, but not limited to, magnetic or optical disks or tape. Such additional storage is illustrated in FIG. 2 by removable storage 138 and non-removable storage 140. Computer storage media includes volatile and nonvolatile, removable and non-removable media implemented in any method or technology for storage of information such as computer readable instructions, data structures, program modules or other data. Memory 134, removable storage 138 and non-removable storage 140 are all examples of computer storage media. Computer storage media includes, but is not limited to, RAM, ROM, EPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by system 130. Any such computer storage media may be part of system 130.

System 130 may also contain communications devices 142 that allow the system to communicate with other systems. Communications devices 142 send and receive communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. The term computer readable media as used herein includes both storage media and communication media.

System 130 may also have input device(s) 144 such as keyboard, mouse, pen, stylus, voice input device, touch input device, etc. Output device(s) 146 include display, speakers, printer, etc. All these devices are well known in the art and need not be discussed at length here. A computing device, such as computing system 130, typically includes at least some form of computer-readable media. Computer readable media can be any available media that can be accessed by the computing system 130. By way of example, and not limitation, computer-readable media might comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 130.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

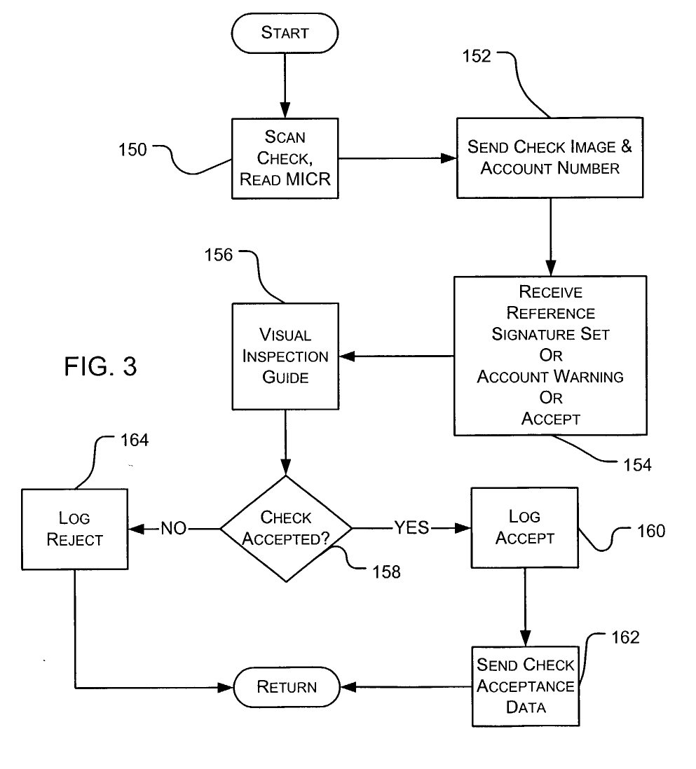

In FIG. 3 one embodiment of the operation flow for the point of sale system 104 in FIG. 1 is shown. The operation flow begins at scan operation 150 when the sales clerk inserts the transaction check into a scanner. The scanner scans the transaction check to capture an image of the signature and also reads the MICR codes at the bottom of the check. Send module 152 interprets the MICR codes to identify the account number of the checking account on which the check is drawn. The account number includes the checking account number and the bank tracking number. Send module 152 sends the check image or the signature image along with the account number to a storage device in the point of sale system 104 and also sends the check or signature image and account number to the verification system 106 in FIG. 1. In both systems the check image or the signature image will be stored in association with the account number. The point of sale system then waits to receive a response from the verification system.

While in this embodiment only the signature image is stored, the entire check image could be stored. This might be useful in combining embodiments of the present invention with other check processing systems such as those that read and verify the amount of the check. Further, the interpretation of the MICR codes to identify the account number could be performed at the verification system if the MICR codes are sent to the verification system.

Receive operation 154 will receive three possible responses from the verification system 106 or account tracking service 114 in FIG. 1. These responses are a reference signature set, an account warning message or an accept check message. The visual inspection guide module 156 operates to begin a dialogue with the sales clerk to guide the sales clerk in accepting or refusing the check. If the guide module 156 receives an accept check message from receive operation 154, the guide module displays an “Accept Check” message to the clerk and the operation flow proceeds to the check acceptance test 158. When the check is accepted, the operation flow branches YES from test 158 to log acceptance operation 160 to log the accepted check in the point of sale system. In this event send operation 162 sends check acceptance data to database manager module 112 in FIG. 1. This check acceptance data includes the account number and the signature image from the transaction check. The database manager module adds the signature image to the signature reference set for that account number in database 110 in FIG. 1.

If the visual inspection guide module 156 receives an account warning message, the account warning message will be displayed to the sales clerk, and the sales clerk will have the option to perform a visual inspection and follow other check processing rules established by the retail store. If the clerk decides not to accept the check, a not accepted check condition is detected by check acceptance test 158, and the operation flow branches NO to log rejection operation 164 to log a rejected check. The operation flow then returns to the main program in the point of sale system.

If the visual inspection guide module 156 receives a reference signature set indicating the signature was not verified, a dialogue leads the sales clerk through a visual inspection of the check signature. First, a message will be displayed to the clerk that the signature was not verified. Also an image of the signature on the transaction check will be displayed in parallel with the signatures from the reference signature set for the account number on the transaction check. The sales clerk will have expanded or blown-up images of the signatures on the display screen to examine similarities between the reference signatures and the check signature. If the sales clerk elects to accept the check, then an accept check input is input by the clerk into the point of sale system 104. Check acceptance test 158 detects accept check input and branches the operation flow to log acceptance operation 160. Log acceptance operation records the acceptance of the check and the point of sale system proceeds to operation 162. Send operation 162 sends the check signature image along with the account number or account identifier to the database manager module 112 in FIG. 1. The operation flow then returns to the main program in the point of sale system. If the sales clerk elects not to accept the check after comparing signatures, then a reject check input is entered into the system by the clerk. Check acceptance test 158 detects the rejection of the check and logs the rejection at the point of sale system. The program flow then returns to the main program.

In summary, the point of sale system after scanning in the check image and MICR code provides the check signature image and account identifier to the verification system and to the point of sale system. The point of sale system looks for a response from the verification system and guides the sales clerk through check acceptance or check rejection. If the check is accepted, then the signature image along with the account identifier is sent from the point of sale system to the database manager so that the check signature image may be added to the reference signature set for that account.

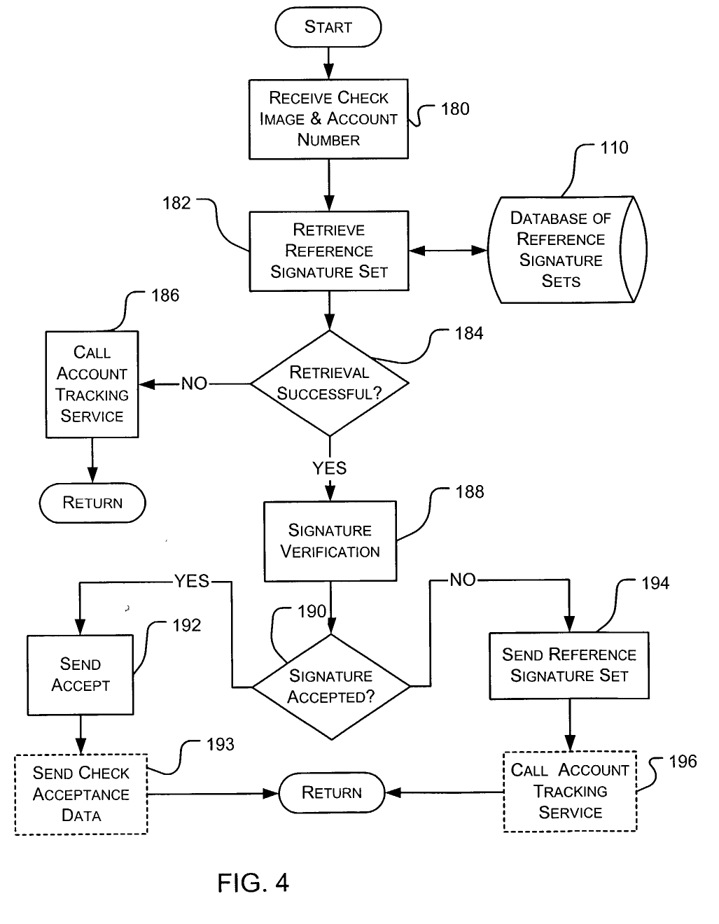

FIG. 4 shows the operational flow in one embodiment of the invention for the verification system. The verification operational flow begins when the system receives the check or signature image and account number at receive operation 180. The signature image is stored for later use by a signature verification operation. The account number is used to retrieve a reference signature set for that account from database 110. Retrieve operation 182 searches the database based on the account number and retrieves the reference signature set for that checking account. Retrieval test operation 184 tests whether the retrieval of a reference signature set was successful. If the retrieval is not successful, the operation flow branches NO to the call operation 186. Call operation 186 calls the account tracking service 114. Service 114 will compare the account number against a list of accounts and send a message to the point of sale system indicating whether the account is an account with a history of bad checks or its use as detected from the check image is outside a range of historical parameters.

If the retrieval of the reference signature set is successful, the operation flow branches YES to the signature verification operation 188. Signature verification operation 188 is an image matching operation. The check signature image of the transaction check received from the point of sale system is compared or matched against signatures in the reference signature set from database 110. Any number of image matching systems might be used. The images might be overlaid, the signature strokes might be broken down and compared stroke by stroke, the signature might be compared as a whole or the signature might be compared character by character. Any one of these electronic and optical matching techniques for comparing two images may be used to perform the signature verification operation 188. Typically, the matching would produce a confidence value or similarity value as an output. This would be a measure of the confidence in a match between or the similarity between the check signature and each signature in the reference signature set. It might be the value of the best match or the average value of all the matches. Alternatively, instead of matching the input signature with each reference signature, the matching might be performed between the input signature and a reference set image representing a set of signatures for a given account. This reference set image might be constructed, for example, as a superposition of all of the reference signatures in the reference signature set. Techniques other than superposition may be used to construct a representative image for the reference signature set. However, the matching is performed, if the confidence value or similarity value exceeds an acceptance threshold, the check signature would be verified.

Signature acceptance test 190 tests the similarity or confidence value against a threshold value. If the signature confidence value exceeds the threshold, then the operation flow branches YES to send accept operation 192. Send accept operation 192 sends the accept message 111 to the point of sale processor 104 in FIG. 1. If the signature confidence value from signature verification 188 does not exceed the acceptance threshold value, the operation flow branches NO to send reference set operation 194. Operation 194 sends the reference signature set to the point of sale system 104 for use in a visual comparison by the sales clerk against the check signature image. The operation flow in the verification system then returns to the main program flow.

Alternatively, in another embodiment, and as represented by dash lines for call operation 196, the verification system may call the account tracking service 114. In this instance, even though there were reference signatures for the account, the signature verification failed. It may be useful to provide the point of sale system the reference signature set and warning messages from the account tracking service.

Also, in another embodiment, and as represented by dash lines for send operation 193, the verification system may send the check acceptance data to database manager 112 (FIG. 1). Since the verification system has the account number and the signature image, i.e. the check acceptance data, the verification system may send the data to the database manager 112 to add the verified signature to the signature reference set.

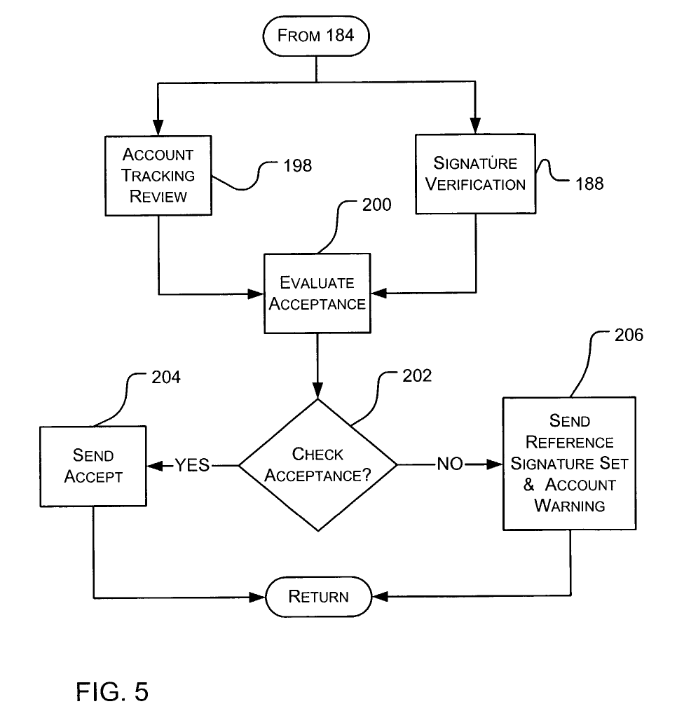

In another embodiment of the invention, as shown in FIG. 5, the account tracking review is a part of the verification system. In the embodiment of FIG. 5, after retrieval test operation 184 (FIG. 4) detects successful retrieval of a reference signature set, the operation flow enters FIG. 5 and signature verification is performed in parallel with an account review by account tracking review operation 198. The signature verification operation 188 proceeds as previously described in FIG. 4. The account tracking review operation is the same as that provided by the external services described with reference to FIG. 4. The account tracking review checks the account number against a list of accounts to detect whether bad checks have previously been issued on the account and whether the present use of the account is within historical parameters. With the account tracking review information available and the signature verification information available, evaluate module 200 evaluates whether the check should be accepted. The two pieces of information, signature verification and account history, add an extra dimension of reliability to the check acceptance evaluation. Normally, a check from a bad account would block acceptance of a check even if the check signature was verified by the signature verification operation. However, the evaluate module 200 could provide additional testing, such as the length of time since the last bad check, number of bad checks, recent checks of similar amount or at a similar location. If the signature verification had a high confidence value, the check might still be accepted if the last bad check was more than a predetermined time in the past or the number of bad checks over a long period of time was below a threshold number or recent history supports similar checks. In another embodiment, the evaluation module might simply subtract off a value from the signature verification confidence value based on the fact that the check comes from a bad account, i.e. an account with a history of problems, or there is some warning message associated with the check. In this case the evaluate acceptance module 200 would issue an acceptance evaluation value. Of course the evaluation module could issue a yes or no acceptance decision.

Check acceptance test operation 202 would receive the evaluation value or the acceptance decision. Operation 202 tests the acceptance value against an acceptance threshold or it detects the acceptance decision. If the threshold was exceeded or the decision was to accept, the operation flow would branch YES to send accept operation 204. Send operation 204 would send the acceptance message to the point of sale system, and the operation flow in the verification system would return to its main program. If the evaluation value was below an acceptance threshold or the acceptance decision was no, then the operation flow would branch NO to send reference set operation 206. Operation 206 would send the reference signature set and an account warning message, if applicable, to the point of sale system for use by the sales clerk in visually inspecting the check. Thereafter, the operation flow in the verification system returns to the main program in the verification system.

In summary, the verification system retrieves reference signature sets from the database 110 based on the account number. It further compares signatures in this reference signature set for the account against the check signature image received from the point of sale system. A number of signature matching systems can be used to produce a confidence value or similarity value as a measure of the match between the check signature and signatures in the signature set. If the signature or confidence value exceeds a threshold, then the verification system will send an accept message to the point of sale system. If the check signature confidence value does not meet an acceptance threshold, then the verification system will send the reference signature set to the point of sale system.

In addition, the verification system may work with the account tracking review in a number of ways. First, if the retrieval of a signature set is not successful, then the verification system can issue a call to an account tracking service. If the retrieval of a signature set is successful, then the verification system may either perform an account tracking review itself, as well as performing signature verification, or it may elect to call the account tracking service only if the signature verification is not successful.

In another embodiment of the invention, the signature verification operation might be blocked for 30 to 60 days for new accounts. This would prevent fraudulent signatures in the database from being used to satisfy signature verification before the actual account holder had built a reference signature set. In another embodiment, the signature verification operation might be blocked until a predetermined number of signatures were in the reference signature set.

In another embodiment the signature verification might be blocked unless the amount of the check exceeded a predetermined amount. Typically, forged checks are written for large amounts, for example a thousand dollars or more. In another embodiment the acceptance threshold for signature verification might be raised based on the amount of the check. The larger the amount of the check the higher the required signature confidence value to pass a valid signature test. In both of these embodiments working with the amount of the check, the amount would be passed from the point of sale system to the verification system along with the signature image and the account number.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

What is claimed is:

1. A signature verification system for verifying a signature on a bank check received at a point of sale system comprising:
a retrieve module retrieving a reference signature set having a plurality of signatures by one or more account owners of a checking account on which the check is drawn;
a signature verification module comparing the signature on the check against the signatures in the reference signature set;
a send acceptance module sending an accept message to the point of sale system if the signature verification module verifies the signature; and
a send reference module for sending the reference signature set to the point of sale system if the signature verification does not verify the signature.

2. The signature verification system of claim 1 further comprising:
a receive module receiving a check signature image and an account number from the point of sale system for the bank check received at the point of sale system; and
said retrieve module retrieves the reference signature set for the checking account identified by the account number.

3. The signature verification system of claim 2 further comprising:
call module for calling a account tracking service module if said retrieve module is not successful in retrieving the reference signature set identified by the account number; and
said account tracking service module warning the point of sale system if the checking account identified by the account identifier has a history of bad checks.

4. The signature verification system of claim 3 wherein the point of sale system comprises:
a guide module in response to an accept message displaying message to accept the check;
send check data module in response to the accept message sending the check signature image and account number to a database of reference signature sets to be added to a reference signature set associated with the account number.

5. The signature verification system of claim 4 wherein the point of sale system further comprises:
said guide module in response to the reference signature set displaying the reference signature set.

6. The signature verification system of claim 5 wherein the point of sale system further comprises:
said guide module in response to an account warning displaying the warning.

7. The signature verification system of claim 3 wherein the point of sale system comprises:
a scanner scanning the check to capture the signature image and to read the account number on the check;
a send signature module sending the signature image and the account number to the signal verification module.

8. The signature verification system of claim 7 wherein the point of sale system further comprises:
a guide module in response to the reference signature set displaying the reference signature set and the signature image.

9. The signature verification system of claim 8 wherein the point of sale system further comprises:
send check data module in response to an accept input at the point of sale system sending the check signature image and account number to a database of reference signature sets to be added to a reference signature set associated with the account number.

10. A method for providing information to a point of sale system to assist in preventing a bank check having a fraudulent signature from being accepted at the point of sale, the method comprising:
receiving a check signature scanned from the bank check and an account identifier read from the bank check;
retrieving from a database a reference signature set associated with the account identifier;
comparing the check signature against reference signatures in the reference signature set to verify the check signature and generating a signature confidence value based on how closely the check signature matches one or more of the reference signatures; and
testing the signature confidence value to accept or not accept the check signature.

11. The method of claim 10 further comprising:
calling a account tracking service if the act of retrieving the reference signature set does not retrieve a reference signature set; and
sending the account identifier to the account tracking service.

12. The method of claim 11 wherein the account tracking service comprises:
comparing the account identifier to a list of checking account identifiers for bad checking accounts, each bad checking account having a history of one or more bad checks being issued against the bad checking account; and
sending to the point of sale system an account message indicating whether or not the account identifier matches a checking account identifier of a bad checking account.

13. The method of claim 11 further comprising:
sending an accept message to the point of sale system if the act of testing accepts the check signature.

14. The method of claim 13 further comprising:
adding the check signature to the reference signature set for the checking account identified by the check identifier if the act of testing accepts the check signature.

15. The method of claim 11 further comprising:
sending the reference signature set to the point of sale system if the act of testing does not accept the check signature.

16. The method of claim 11 further comprising:
receiving from the point of sale system an add signature message;
adding the check signature to the reference signature set for the checking account identified by the check identifier when the add signature message is received.

17. The method of claim 10 further comprising:
sending an accept message to the point of sale system if the act of testing accepts the check signature.

18. The method of claim 10 further comprising:
adding the check signature to the reference signature set for the checking account identified by the check identifier if the act of testing accepts the check signature.

19. The method of claim 10 further comprising:
sending the reference signature set to the point of sale system if the act of testing does not accept the check signature.

20. The method of claim 10 further comprising:
receiving from the point of sale system an add signature message;
adding the check signature to the reference signature set for the checking account identified by the check identifier when the add signature message is received.

21. Apparatus for verifying a customer signature on a funds document received in a transaction at a point of sale station, the funds document being drawn on an account identified by an account number on the funds document, said apparatus comprising:
means for storing customer signatures from previous transactions as reference signatures in a reference signature set associated with an account number, the customer signatures and account number being received from one or more point of sale stations as a result of a plurality of transactions at said one or more stations;
means for retrieving the reference signature set based on the account number identified in the current transaction;
means for comparing the current customer signature from the current transaction to one or more reference signatures in the reference signature set and indicating whether or not there is a match between the current customer signature and one or more reference signatures;
means for sending a valid signature message to the point of sale station if said comparing means indicates there is a match between the current customer signature and one or more reference signatures.

22. The apparatus of claim 21 further comprising:
means responsive to a valid signature message for adding the current customer signature as a reference signature associated with the account number.

23. The apparatus of claim 21 further comprising:
means responsive to a document acceptance message from the point of sale station for adding the current customer signature to the reference signature set associated with the account number.

24. The apparatus of claim 21 further comprising:
means for sending the reference signature set to the point of sale station if said comparing means indicates there is not a match between the current customer signature and one or more reference signatures.

25. The apparatus of claim 24 further comprising:
means for comparing the account number to a list of account numbers and sending an account warning message to the point of sale station if a record for the current account number indicates a bad check incident or a departure from use history parameters.

26. The apparatus of claim 21 further comprising:
means for comparing the account number to a list of account numbers and sending an account warning message to the point of sale station if said means for retrieving fails to retrieve a reference signature set.

27. The apparatus of claim 21 further comprising:
means responsive to the valid signature message for displaying a valid signature message and a first dialogue at the point of sale station to guide acceptance of the funds document;
means responsive to the reference signature set from said set sending means for displaying the reference signature set and a second dialogue at the point of sale station to guide visual inspection of the signature on the funds document; and
means responsive to a funds document accepted input at the point of sale station for sending the current customer signature to said storing means to add the current customer signature to the reference signature set.

28. A computer program product readable by a computing system and encoding a computer program of instructions for executing a computer process for verifying a customer signature on a funds document received in a transaction at a point of sale station, the funds document being drawn on an account identified by an account number on the funds document, said computer process comprising:
storing customer signatures from previous transactions as reference signatures in a reference signature set associated with an account number, the customer signatures and account number being received from one or more point of sale stations as a result of a plurality of transactions at said one or more stations;
retrieving the reference signature set based on the account number identified in the current transaction;
comparing the current customer signature from the current transaction to one or more reference signatures in the reference signature set and indicating whether or not there is a match between the current customer signature and one or more reference signatures;
sending a valid signature message to the point of sale station if said comparing means indicates there is a match between the current customer signature and one or more reference signatures.

29. The computer program product of claim 28 wherein the computer process further comprises:
in response to a valid signature message, adding the current customer signature as a reference signature associated with the account number.

30. The computer program product of claim 28 wherein the computer process further comprises:
in response to a document acceptance message from the point of sale station, adding the current customer signature to the reference signature set associated with the account number.

31. The computer program product of claim 28 wherein the computer process further comprises:
sending the reference signature set to the point of sale station if said act of comparing indicates there is not a match between the current customer signature and one or more reference signatures.

32. The computer program product of claim 31 wherein the computer process further comprises:
comparing the account number to a list of account numbers and sending an account warning message to the point of sale station if the current account number matches an account number in the list of account numbers.

33. The computer program product of claim 28 wherein the computer process further comprises:
sending an account warning message to the point of sale station if said means for retrieving fails to retrieve a reference signature set.
